(19) United States
(12) Patent Application Publication
(10) Pub. No.: US 2012/0243906 A1
(43) Pub. Date: Sep. 27, 2012

(54) IMAGE HOLDING MEMBER UNIT AND IMAGE FORMING APPARATUS

(75) Inventor: Kaoru WATANABE, Kanagawa (JP)

(73) Assignee: FUJI XEROX CO., LTD., Tokyo (JP)

(21) Appl. No.: 13/269,263

(22) Filed: Oct. 7, 2011

(30) Foreign Application Priority Data
Mar. 25, 2011 (JP) 2011-068762

(51) Int. Cl. G03G 21/18

(52) U.S. Cl. 399/114

(57) ABSTRACT

An image holding member unit includes an image holding member having a rotation shaft rotatably supported by a support member and holding a developer image on an outer circumferential surface thereof, a protective member moving between a first position and a second position, and a guide structure including a first link member of which an end is rotatably linked to the rotation shaft and the other end of which is rotatably linked to an end of the protective member in a circumferential direction of the image holding member and a second link member of which an end is rotatably linked to the other end of the protective member in the circumferential direction and the other end of which is rotatably linked to the support member and guiding the protective member between the first position and the second position.

### CROSS-REFERENCE TO RELATED APPLICATIONS

This application is based on and claims priority under 35 USC 119 from Japanese Patent Application No. 2011-068762 filed Mar. 25, 2011.

### BACKGROUND

### Technical Field

The present invention relates to an image holding member unit and an image forming apparatus.

### SUMMARY

According to an aspect of the invention, there is provided an image holding member unit including: an image holding member that has a rotation shaft which is rotatably supported by a support member and that holds a developer image on an outer circumferential surface thereof; a protective member that moves between a first position where the protective member covers the outer circumferential surface of the image holding member and a second position where the protective member uncovers the outer circumferential surface of the image holding member; and a guide structure that includes a first link member of which an end is rotatably linked to the rotation shaft and the other end of which is rotatably linked to an end of the protective member in a circumferential direction of the image holding member and a second link member of which an end is rotatably linked to the other end of the protective member in the circumferential direction of the image holding member and the other end of which is rotatably linked to the support member and that guides the protective member between the first position and the second position.

### BRIEF DESCRIPTION OF THE DRAWINGS

Exemplary embodiments of the present invention will be described in detail based on the following figures, wherein:

FIG. 1 is a perspective view illustrating the appearance of an image forming apparatus according to an exemplary embodiment of the invention;

FIG. 2 is a configurational diagram illustrating the internal structure of the image forming apparatus according to the exemplary embodiment of the invention;

FIG. 3 is a configurational diagram illustrating a state where a front cover and a top cover are opened in the image forming apparatus according to the exemplary embodiment of the invention;

FIG. 4 is a configurational diagram illustrating a state where four photosensitive member units are opposed to a transfer belt according to the exemplary embodiment of the invention;

FIG. 5 is a configurational diagram illustrating a main part of a photosensitive member unit according to the exemplary embodiment of the invention;

FIG. 6 is a perspective view illustrating the surfaces of a first shutter and a second shutter facing the photosensitive member according to the exemplary embodiment of the invention;

FIGS. 7A and 7B are diagrams illustrating a state where a lever member is pushed in when a cover member of the image forming apparatus according to the exemplary embodiment of the invention is shut;

FIGS. 8A and 8B are diagrams illustrating a state where the lever member according to the exemplary embodiment of the invention is pushed into cause the first shutter member and the second shutter member to move;

FIGS. 9A and 9B are diagrams illustrating a four-joint link structure of the first shutter member and the second shutter member according to the exemplary embodiment of the invention;

FIGS. 10A and 10B are perspective views illustrating states where the first shutter member and the second shutter member according to the exemplary embodiment of the invention are located at a protective position and an evacuated position;

FIGS. 11A and 11B are sectional views illustrating the states where the first shutter member and the second shutter member according to the exemplary embodiment of the invention are located at the protective position and the evacuated position; and

FIG. 12 is a diagram illustrating sites of application of forces in the longitudinal direction of the first shutter member according to the exemplary embodiment of the invention.

### DETAILED DESCRIPTION

Hereinafter, an example of an image holding member unit and an image forming apparatus according to an exemplary embodiment of the invention will be described with reference to the accompanying drawings.

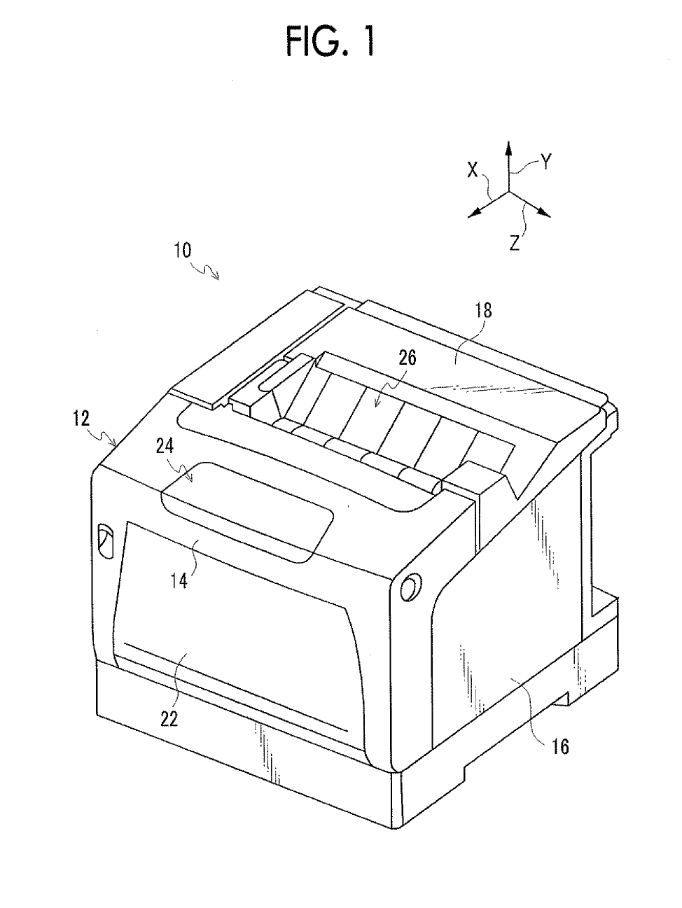

FIG. 1 shows an image forming apparatus 10 as an example of the exemplary embodiment. The image forming apparatus 10 includes a casing 12 as an apparatus body. The casing 12 includes a front cover 14 constituting the front surface of the image forming apparatus 10, a side cover 16 constituting the side surface thereof, and a top cover 18 constituting the top surface thereof. In the following description, when the front cover 14 is viewed from the front side, the direction directed from the back surface to the front surface of the image forming apparatus 10 is defined as an X direction, the direction (the vertical direction) directed from the bottom surface to the top surface is defined as an Y direction, and the direction directed from the left side surface to the right side surface is defined as a Z direction.

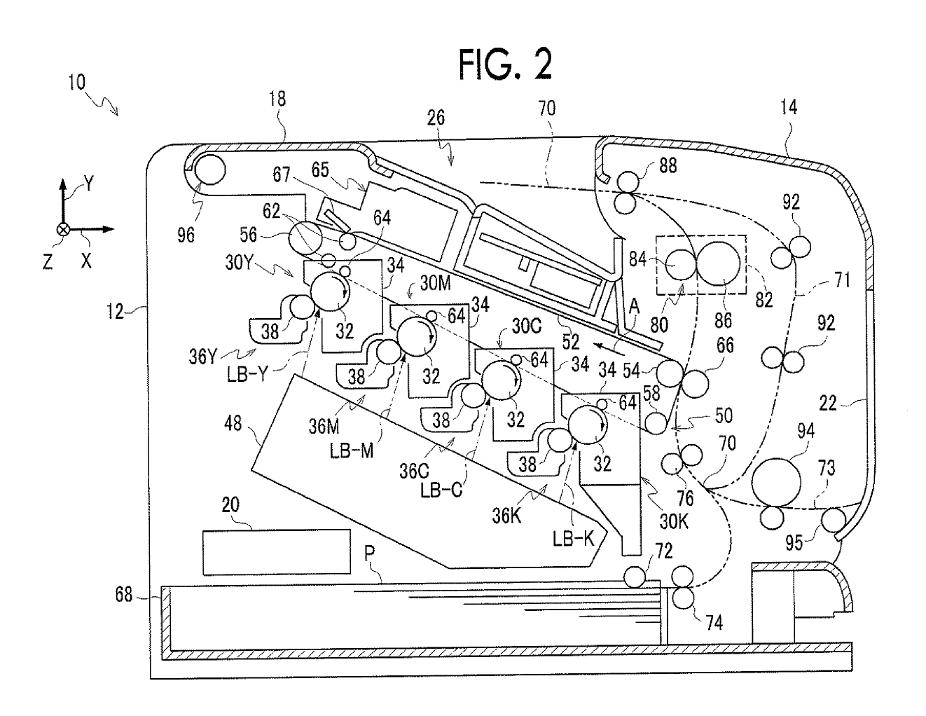

The front cover 14 is formed in an L shape over the front surface and the top surface of the image forming apparatus 10 as seen in the direction of arrow Z. In the front cover 14, a manual bypass tray 22 is disposed to be opened in the direction of arrow X and an operation panel 24 is disposed above the manual bypass tray 22 in the front cover 14. The operation panel 24 is connected to a control unit 20 (see FIG. 2) controlling the operation of the elements of the image forming apparatus 10. A discharge tray 26 to which a recording sheet P (not shown) having an image formed thereon is discharged is disposed on the top cover 18.

As shown in FIG. 2, photosensitive member units 30Y, 30M, 30C, and 30K (hereinafter, simply referred to as the photosensitive member units 30 when the colors are not distinguished from each other) as an example of the image holding member unit corresponding to the toner colors of yellow (Y), magenta (M), cyan (C), and black (K) are disposed in the casing 12.

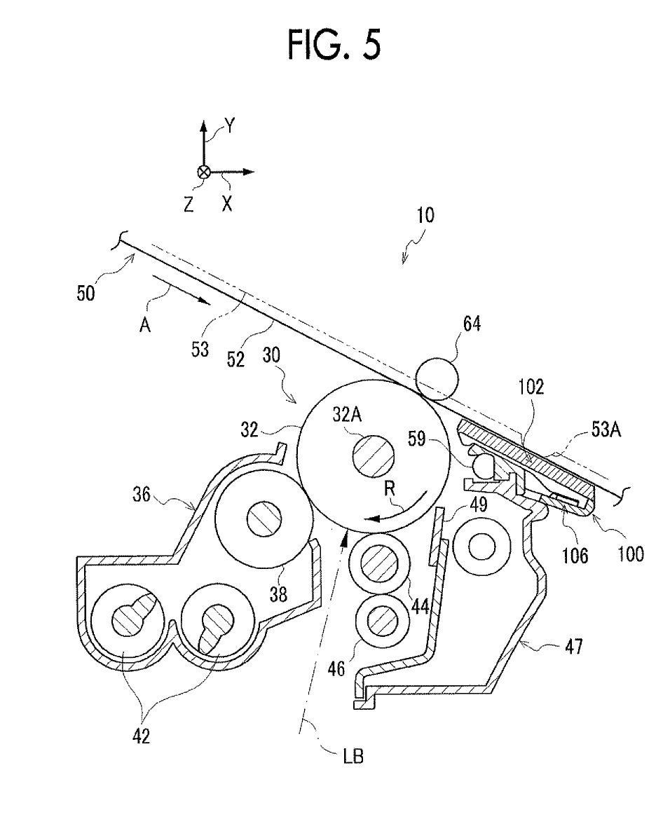

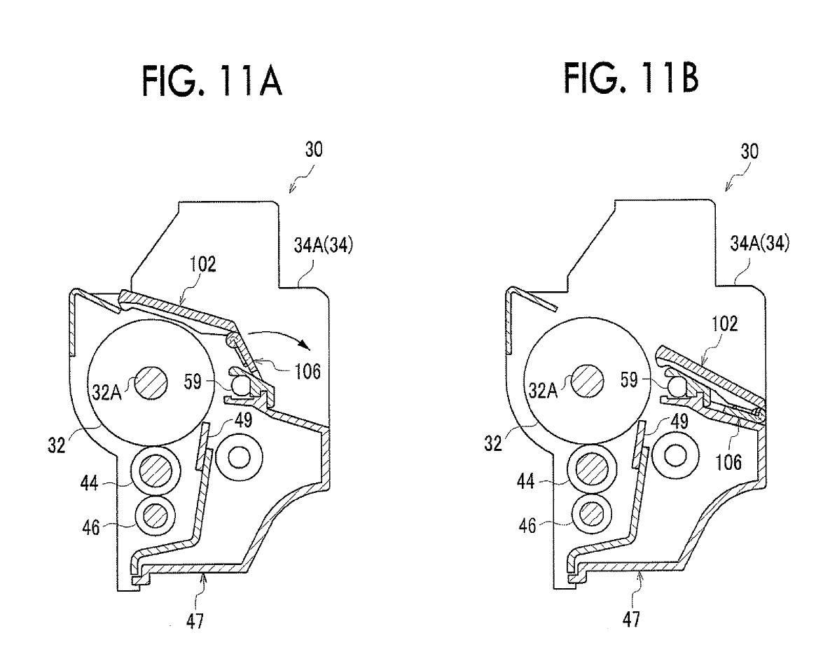

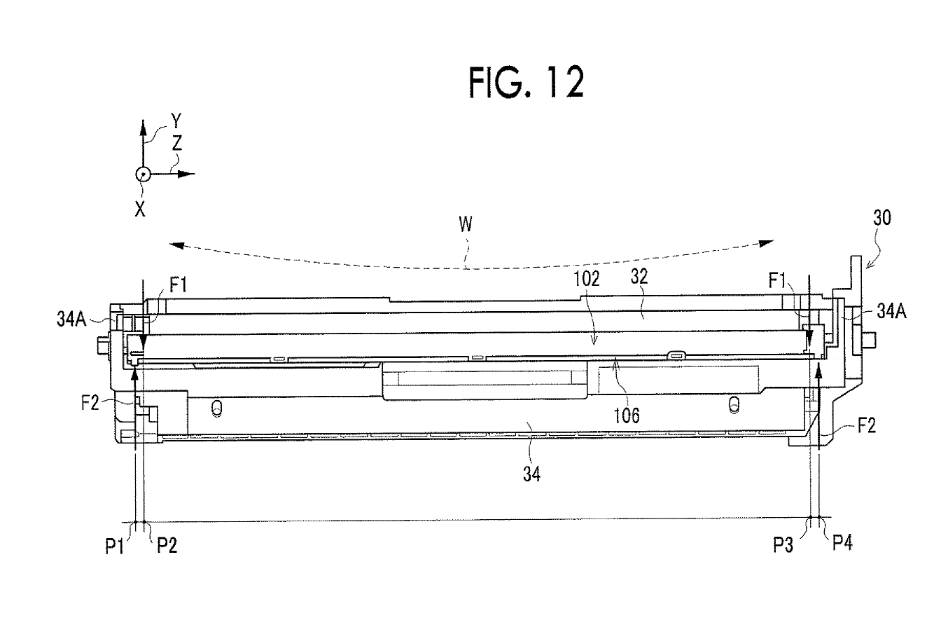

Each photosensitive member unit 30 includes a box-like unit body 34 as an example of the support member. A photosensitive member 32 as an example of the image holding member having a columnar shape and holding a latent image, which is changed to a developer image with toner (developer), on the outer circumferential surface thereof is disposed in the unit body 34. The photosensitive member 32 has a rotation shaft 32A (see FIG. 5) with the direction of arrow Z as an axial direction and the rotation shaft 32A is rotatably supported by side plates 34A (see FIGS. 11A and 11B) constituting a part of the unit body 34.

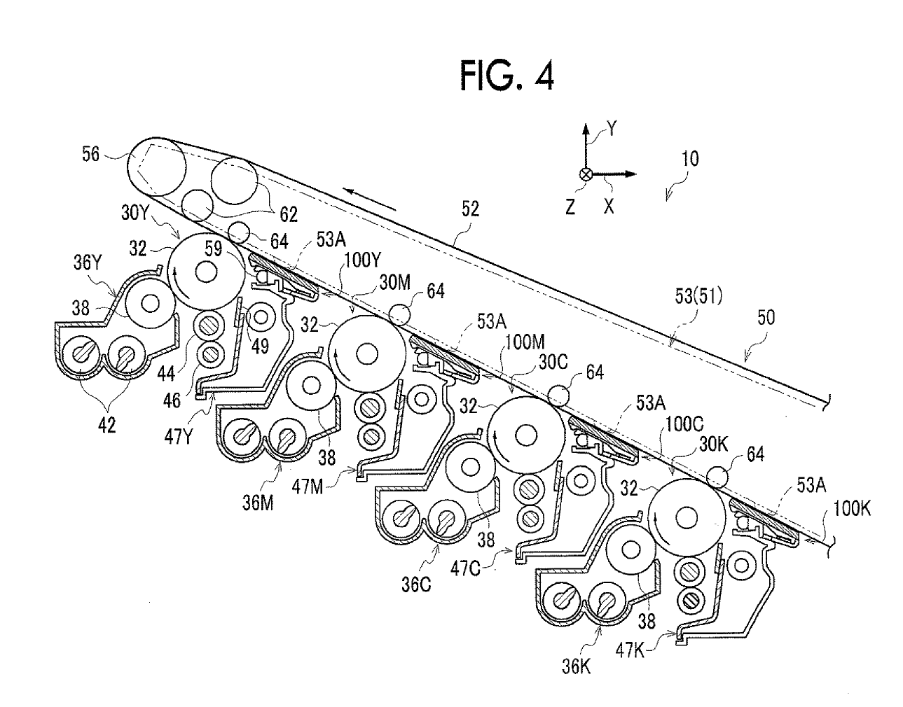

Each photosensitive member unit 30 includes a shutter unit 100 (see FIGS. 4 and 5) protecting the photosensitive member 32 when the photosensitive member unit 30 is taken out of the image forming apparatus 10. The detailed configuration of the shutter unit 100 will be described later. Developing devices 36Y, 36M, 36C, and 36K (hereinafter, simply referred to as the developing units 36 when the colors are not distinguished from each other) are disposed adjacent to the photosensitive member units 30Y, 30M, 30C, and 30K in the casing 12.

As shown in FIG. 5, the respective developing devices 36 are filled with toner and carriers (the developer) with the supply of toner from toner cartridges (not shown in the drawings) mounted on the casing 12. The developer is agitated and supplied with the rotation of a spiral supply member 42 disposed therein. In the respective developing devices 36Y, 36M, 36C, and 36K, a developing sleeve 38 having a magnetic member (not shown in the drawings) including plural magnetic poles is rotatably disposed. The developing sleeve 38 transports a developer layer formed on the outer circumferential surface thereof to the position where it is opposed to the corresponding photosensitive member 32 with the rotation thereof and attaches the toner to the latent image (the electrostatic latent image) formed on the outer circumferential surface of the photosensitive member 32 to develop the latent image, whereby a toner image (the developer image) is formed.

A charging roll 44 charging the outer circumferential surface (the surface) of the corresponding photosensitive member 32 is rotatably disposed at a position at which it comes in contact with the outer circumferential surface of the photosensitive member 32 and which is more upstream than the developing sleeve 38 in the circumferential direction (which is the direction of arrow R and the rotation direction of the photosensitive member 32 in this exemplary embodiment) of the photosensitive member 32. The charging roll 44 is supplied with power from a power source (not shown) to charge the outer circumferential surface of the photosensitive member 32 to the same polarity as the toner on the basis of the potential difference from the photosensitive member 32 of which the inside is grounded. A cleaning roll 46 cleaning the outer circumferential surface of the charging roll 44 is rotatably disposed on the opposite side of the photosensitive member 32 on the outer circumferential surface of the charging roll 44.

A cleaning unit 47 cleaning the outer circumferential surface of the photosensitive member 32 after transferring the toner image is disposed more downstream than a primary transfer roll 64 to be described later in the circumferential direction of the photosensitive member 32. The cleaning unit 47 includes a cleaning blade 49 of which an end comes in contact with the outer circumferential surface of the photosensitive member 32 and stores the toner raked out by the cleaning blade 49. A discharging lamp 59 discharging the outer circumferential surface of the photosensitive member 32 after the primary transfer so as to enable the cleaning is disposed at a position which is more downstream than the primary transfer roll 64 in the circumferential direction of the photosensitive member 32 and more upstream than the cleaning blade 49.

As shown in FIG. 2, an exposing unit 48 is disposed below the photosensitive member units 30 and the developing devices 36 in the casing 12. For example, the exposing unit 48 includes a light source including a semiconductor laser and optical components such as a polygon mirror and a reflecting mirror (all of which are not shown in the drawings). The exposing unit 48 scans and irradiates the surfaces of the photosensitive members 32 charged by the charging rolls 44 with laser beams LB (laser beams LB-Y, LB-M, LB-C, and LB-K) emitted from the light source, whereby electrostatic latent images corresponding to image information are formed on the surfaces of the photosensitive members 32. The light source used to form the electrostatic latent images on the photosensitive members 32 is not limited to the semiconductor layer, but light-emitting elements such as LED may be arranged to emit light on the basis of the image information.

As shown in FIGS. 2 and 4, an intermediate transfer unit 50 is disposed above the four photosensitive members 32 corresponding to the colors. The intermediate transfer unit 50 includes a driving roll 54, a driven roll 56, a tension roll 58, and a transport roll 62 which are described later, a housing 51 as an example of the support body supporting the rolls so as to be rotatable, and an intermediate transfer belt 52 as an example of the transfer belt supported by the rolls so as to circulate in the direction of arrow A.

The housing 51 includes side plates 53 being disposed upright outside the intermediate transfer belt 52 in the direction of arrow Z and rotatably supporting the driving roll 54, the driven roll 56, the tension roll 58, and the transport roll 62. Protruding portions 53A pressing a first shutter member 102 (to be described later) downward (the side opposite to the intermediate transfer belt 52) are formed in the side plates 53.

As shown in FIG. 2, the intermediate transfer belt 52 has an endless shape and is wound on the driving roll 54 being rotationally driven by the control unit 20, the driven roll 56 rotating to follow the driving roll, the tension roll 58 giving a tension to the intermediate transfer belt 52, and plural transport rolls 62 coming in contact with the rear surface of the intermediate transfer belt 52 and rotating to follow the intermediate transfer belt. The intermediate transfer belt 52 circulates in the direction of arrow A (in the counterclockwise direction in the drawings) with the rotation of the driving roll 54. The intermediate transfer belt 52 is disposed more downstream than the respective developing devices 36 in the circumferential direction of the respective photosensitive members 32 and above the respective photosensitive members 32. The toner images formed on the outer circumferential surfaces of the photosensitive members 32 are multiply transferred thereto.

A primary transfer roll 64 primarily transferring the toner image formed on the outer circumferential surface of the corresponding photosensitive member 32 to the intermediate transfer belt 52 is disposed on the opposite side of the respective photosensitive member 32 with the intermediate transfer belt 52 interposed therebetween. The primary transfer rolls 64 come in contact with the rear surface of the intermediate transfer belt 52 and primarily transfer the toner images on the outer circumferential surfaces of the photosensitive members 32 to the intermediate transfer belt 52 on the basis of the potential difference from the photosensitive members 32 which are grounded with the supply of power from a power source (not shown in the drawings). The intermediate transfer belt 52 comes in contact with the outer circumferential surfaces of the photosensitive members 32 in the order of the photosensitive member units 30Y, 30M, 30C, and 30K, whereby the color toner images of Y, M, C, and K are transferred and superimposed thereon.

A secondary transfer roll 66 secondarily transferring the toner images superimposed on the outer circumferential surface of the intermediate transfer belt 52 to a transported recording sheet P is disposed on the opposite side of the driving roll 54 with the intermediate transfer belt 52 interposed therebetween. The secondary transfer roll 66 transfers the toner images on the outer circumferential surface of the intermediate transfer belt 52 to the recording sheet P on the basis of the potential difference from the driving roll 54 which is grounded with the supply of power from the power source (not shown in the drawings).

A cleaning unit 65 is disposed to be opposed to one of the transport rolls 62 on which the intermediate transfer belt 52 is wound. The cleaning unit 65 includes a cleaning blade 67 coming in contact with the outer circumferential surface of the intermediate transfer belt 52 and the intermediate transfer belt 52 passes through between the cleaning blade 67 and the transport roll 62 while coming in contact with the cleaning blade 67, whereby the toner attached to the surface thereof is removed and recovered.

A sheet feed tray 68 storing recording sheets P is disposed in the lower part of the casing 12. In the casing 12, a transporting path 70 through which a recording sheet P is transported is disposed from the sheet feed tray 68 to the discharge tray 26. A pickup roll 72 picking up and sending the stored recording sheets P to the transporting path 70 is disposed above an end in the direction of arrow X of the sheet feed tray 68, and a pair of transport rolls 74 transporting the recording sheets P sheet by sheet is disposed more downstream than the pickup roll 72 in the transport path 70.

A registration roll 76 temporarily stopping the recording sheet P and sending the recording sheet to a secondary transfer position at a predetermined time is disposed more downstream than the transport roll 74 in the transporting direction of the recording sheet P in the transporting path 70. The secondary transfer position is a position where the intermediate transfer belt 52 comes in contact with the secondary transfer roll 66 in the transporting path 70. A fixing device 80 fixing the toner images to the recording sheet P to which the toner images have been transferred by the secondary transfer roll 66 is disposed more downstream than the secondary transfer roll 66 in the transporting path 70.

The fixing device 80 includes a frame 82 and a fixing roll 84 performing a fixing operation by heating and a pressing roll 86 pressing the recording sheet P against the fixing roll 84 are disposed in the frame 82. The fixing roll 84 is disposed in the transporting path 70 so as to face the toner image surface and has a halogen heater (not shown in the drawings) as a heat source therein. The pressing roll 86 contacts and presses the outer circumferential surface of the fixing roll 84 with an impelling force of a spring or the like (not shown in the drawings) to form a contact region (nip part) along with the fixing roll 84.

A pair of discharge rolls 88 discharging the recording sheet P to the discharge tray 26 is rotatably disposed more downstream than the fixing device 80 in the transporting direction of the recording sheet P in the transporting path 70. A double-side transporting path 71 in which a recording sheet P is reversed and transported so as to form images on both sides of the recording sheet P is connected to the transporting path 70.

The double-side transporting path 71 includes plural transport rolls 92, the upper end is connected to the discharge rolls 88, the lower end thereof is connected to the upstream side (front side) of the registration roll 76. A manual bypass transporting path 73 through which a recording sheet P is transported is disposed from the manual bypass tray 22 to the upstream side of the registration roll 76. A pair of feed rolls 94 is disposed in the manual bypass transporting path 73.

Here, when images are formed on both surfaces of a recording sheet P, the leading edge of a recording sheet P which is transported through the transporting path 70 and which has an image formed on the front surface thereof is made to protrude out of the casing 12 by the use of the discharge rolls 88. Then, in the state where the trailing edge of the recording sheet P is interposed between the discharge rolls 88, the recording sheet P is transported to the double-side transporting path 71 and is returned to the registration roll 76 by causing the discharge rolls 88 to reversely rotate and operating a switching guide (not shown in the drawings). The recording sheet P is subjected to an image forming operation on the rear surface thereof and is then discharged to the discharge tray 26.

As shown in FIG. 2, a shaft 95 is disposed at the lower end of the front cover 14. In the image forming apparatus 10, when the front cover 14 is made to rotate about the shaft 95, the front cover 14 is opened in the direction of arrow X. A hinge 96 is disposed at the end (at the left end in the drawing) of the top cover 18 opposite to the discharge tray 26. In the image forming apparatus 10, when the top cover 18 is made to rotate about the hinge 96, the top cover 18 is opened in the direction of arrow Y.

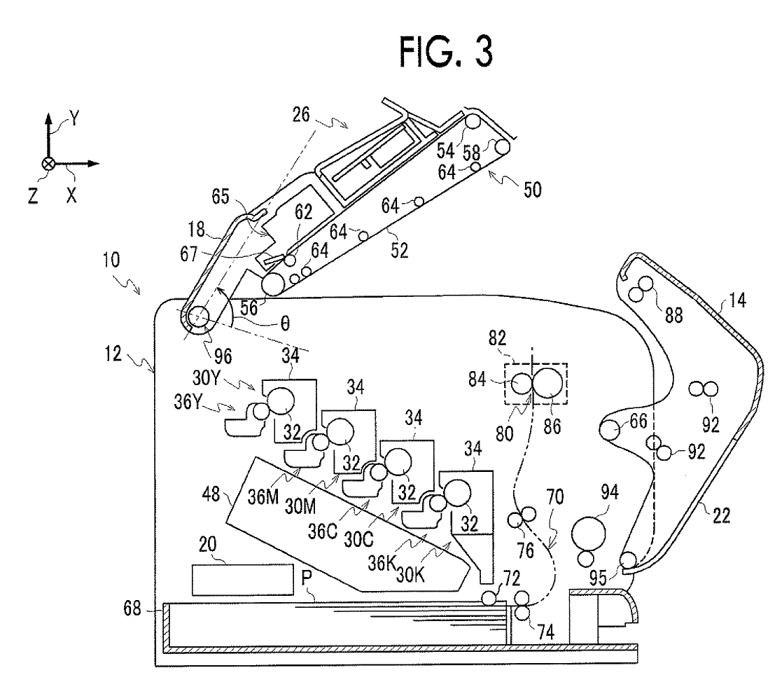

As shown in FIG. 3, when the front cover 14 in the image forming apparatus 10 is opened, the transporting path 70 of the recording sheet P is opened and the recording sheet P failing to be transported can be taken out. In the image forming apparatus 10, the fixing device 80 is opened by opening the front cover 14, whereby the fixing device 80 can be subjected to maintenance. In FIG. 3, the fixing device 80 is located in the normal transporting path 70, but is actually configured to move along with the front cover 14.

In the image forming apparatus 10, the intermediate transfer belt 52 moves along with the top cover 18, by causing the top cover 18 to rotate about the hinge 96 by an angle θ in the direction of arrow Y, whereby the top cover 18 is opened. By opening the top cover 18, the photosensitive member units 30 and the developing devices 36 are exposed so as to perform maintenance such as interchanging members.

The shutter unit 100 will be described below.

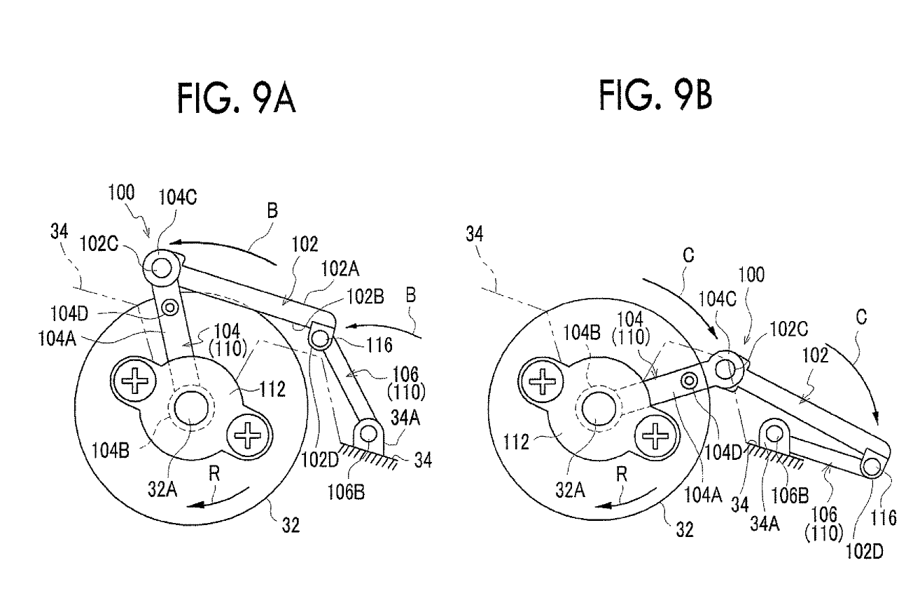

As shown in FIG. 9A, the shutter unit 100 includes a first shutter member 102 as an example of the protective member disposed to be opposed to the outer circumferential surface of the corresponding photosensitive member 32 so as to protect the photosensitive member 32, a link member 104 as an example of the first link member rotatably linked to an end (the left end in the drawing) of the first shutter member 102 in the circumferential direction (the direction of arrow R) of the photosensitive member 32, and a second link member 106 as an example of the second link member rotatably linked to the other end (the right end in the drawing) of the first shutter member 102 in the direction of arrow R. A guide unit 110 as an example of the guide structure is constituted by the link member 104 and the second shutter member 106. The first shutter member 102 is guided between a protective position and an evacuated position to be described later by the guide unit 110. The direction of arrow R is the circumferential direction of the photosensitive member 32.

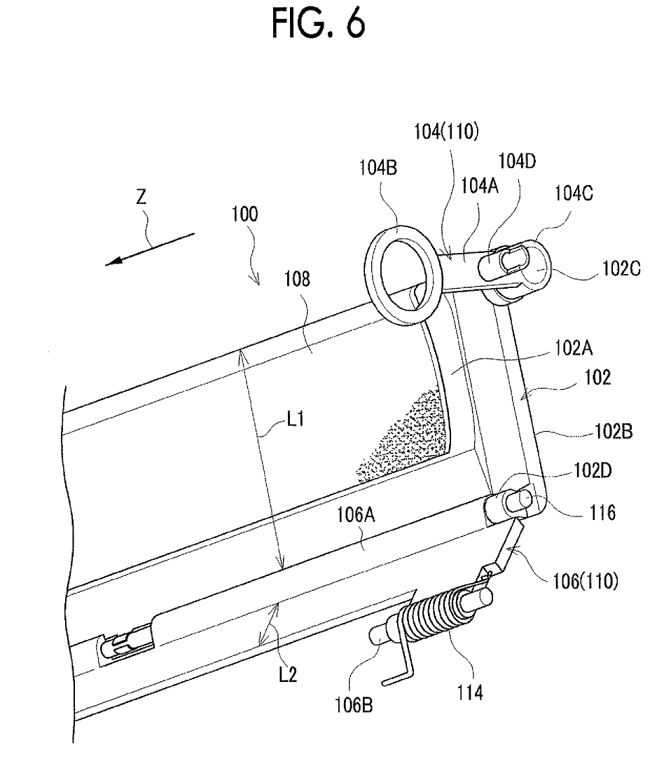

As shown in FIG. 6, the first shutter member 102 is a plate-like member with the direction of arrow Z as a longitudinal direction. A rear surface 102A thereof which is an opposing surface opposed to the outer circumferential surface of the photosensitive member 32 (see FIG. 9A) is formed in a concave shape indented in the direction in which it gets away from the outer circumferential surface of the photosensitive member 32, and the front surface 102B thereof opposed to the intermediate transfer belt 52 (see FIG. 2) is formed in a flat shape. An urethane seal 108 as an example of the elastic member is attached to the rear surface 102A.

A link pin 102C with the direction of arrow Z as an axial direction protruding to the outside is integrated with both ends of the first shutter member 102 in the direction of arrow Z and an end thereof in the transverse direction (the direction perpendicular to the direction of arrow Z). At both ends of the first shutter member 102 in the direction of arrow Z and at the other end in the transverse direction, a cylindrical third link portion 102D with the direction of arrow Z as an axial direction is formed. In FIG. 6, only one end of the shutter unit 100 is shown, but the other end has the same configuration as the one end, except for the link member 104, and thus the other end will not be described.

The link member 104 includes a flat arm 104A, a ring-like first link portion 104B with the direction of arrow Z as an axial direction integrated with an end in the longitudinal direction of the arm 104A, a cylindrical second link portion 104C with the direction of arrow Z as an axial direction integrated with the other end in the longitudinal direction of the arm 104A, and a cylindrical pressing target portion 104D protruding to the opposite side in the direction of arrow Z from the arm 104A.

The second shutter member 106 is a plate-like member with the direction of arrow Z as a longitudinal direction and the length L2 in the transverse direction is shorter than the length L1 in the transverse direction of the first shutter member 102. A cylindrical fourth link portion 106A with the direction of arrow Z as an axial direction is integrated to both ends of the second shutter member 106 in the direction of arrow Z and an end in the transverse direction thereof. A columnar fifth link portion 106B with the direction of arrow Z as an axial direction is integrated with both ends of the second shutter member 106 in the direction of arrow Z and the other end in the transverse direction thereof. The fifth link portion 106B is provided with a sprang 114 impelling the first shutter member 102 and the second shutter member 106 to the corresponding photosensitive member 32 (see FIG. 9A).

Here, as shown in FIGS. 9A and 9B, the rotation shaft 32A of the photosensitive member 32 is inserted into the first link portion 104B disposed at an end of the link member 104 and both ends of the rotation shaft 32A is rotatably supported by pad members 112 attached to the unit body 34. Accordingly, the link member 104 can rotate (be rotatably linked) in the direction of arrow B (in the counterclockwise direction in the drawing) or the direction of arrow C (in the clockwise direction in the drawing) about the same center as the rotation shaft 32A.

The link pin 102C of the first shutter member 102 is inserted into the second link portion 104C disposed at the other end of the link member 104. That is, the other end of the link member 104 is rotatably linked to an end of the first shutter member 102 in the circumferential direction (in the direction of arrow R) of the photosensitive member 32 and the first shutter member 102 can rotate about the link member 104.

In the state where the third link portion 102D of the first shutter member 102 and the fourth link portion 106A (see FIG. 6) of the second shutter member 106 are arranged in the direction of arrow Z, the shaft 116 is inserted into the third link portion 102D and the fourth link portion 106A. In addition, the fifth link portion 106B is inserted into a cylindrical sixth link portion 34A disposed in a part of the unit body 34 and is rotatably supported thereby. That is, an end of the second shutter member 106 is rotatably linked to the other end of the first shutter member 102 in the circumferential direction of the photosensitive member 32 and the other end of the second shutter member 106 is rotatably linked to the unit body 34.

Accordingly, the first shutter member 102 and the second shutter member 106 can rotate about the shaft 116 and the second shutter member 106 can rotate in the direction of arrow B and the direction of arrow C relative to the unit body 34. In this way, in the shutter unit 100, a four-joint link structure having the first link portion 104B (the rotation shaft 32A), the link pin 102C, the shaft 116, and the fifth link portion 106B as joints is formed. The unit body 34 (including the pad members 112) serves as a fixed link.

The position where the first shutter member 102 and the second shutter member 106 cover and protect the photosensitive member 32 (to be opposed to the outer circumferential surface of the photosensitive member 32) is defined as a protective position. That is, when the first shutter member 102 is located at the protective position, the second shutter member 106 also protects the photosensitive member 32. The position where the first shutter member 102 and the second shutter member 106 are evacuated from the protective position where they opposed to the outer circumferential surface of the photosensitive member 32 and are folded is defined as an evacuated position. At the evacuated position, the first shutter member 102 is disposed along the intermediate transfer belt 52 (see FIG. 5).

An interlocking mechanism of the top cover 18 and the shutter unit 100 will be described below.

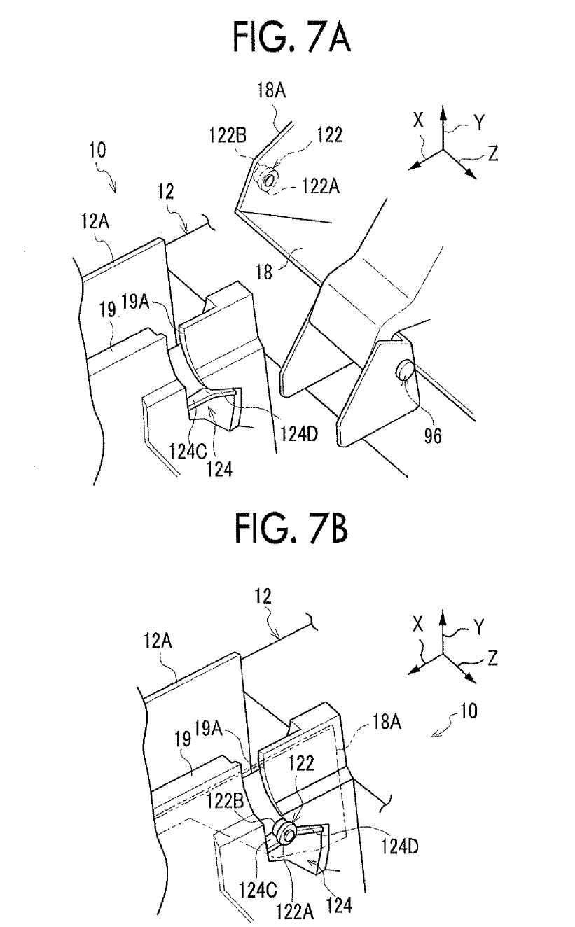

As shown in FIG. 7A, the top cover 18 is disposed in the upper part of the casing 12 so as to be opened up by the hinge 96 and a side plate 18A which is perpendicular to the direction of arrow Z is integrated with an end of the top cover 18 in the direction of arrow Z. A boss 122 protruding to the outside (to the opposite side of the direction of arrow Z) is disposed in the side plate 18A. The boss 122 includes a disc-like attachment portion 122A attached to the side plate 18A and a columnar pressing portion 122B protruding to the outside from the attachment portion 122A.

As shown in FIGS. 7A and 7B, the casing 12 includes a side wall 12A parallel to the X-Y plane perpendicular to the direction of arrow Z. A side plate 19 parallel to the side wall 12A with a gap interposed therebetween is disposed upright on the bottom wall (not shown in the drawing) of the casing 12.

In the side plate 19, an arc-like groove 19A is formed in the locus where the boss 122 rotationally moves about the hinge 96. When the top cover 18 is shut, the boss 122 is guided into the groove 19A and moves downward. A lever member 124 which can be pressed down by the boss 122 moving downward when the top cover 18 is shut is disposed between the side wail 12A and the side plate 19 at the lower end position of the groove 19A so as to be rotatable in the X-Y plane.

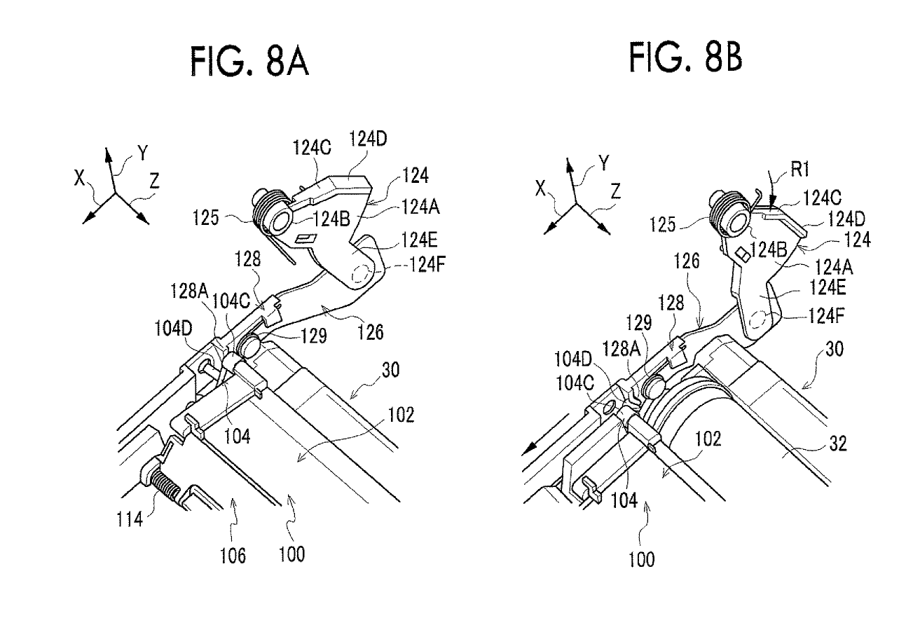

As shown in FIGS. 8A and 8B, the lever member 124 includes a body portion 124A having a fan shape in the X-Y plane and a cylindrical link portion 124B with the direction of arrow Z as an axial direction is integrated with a site which the vertex of the fan shape of the body portion 124A. A contact portion 124C and an inclined portion 124D formed of a flat flange are integrated with each other to cover the top of the body portion 124A from the link portion 124B.

A protruding portion 124E protruding more outside than the outer circumference of the body portion 124A in the radius direction centered on the link portion 124B is integrated with the site of the body portion 124A opposite to the link portion 124B. The link portion 124B is configured to rotate in the direction of arrow R1 about a pin (not shown) disposed in the side plate 19 (see FIGS. 7A and 7B). A torsion spring 125 is disposed to cover the link portion 124B. The torsion spring 125 impels the lever member 124 in the opposite direction of the direction of arrow R1.

A plate-like slide member 126 with the direction of arrow X as a longitudinal direction thereof which is slidable in the direction of arrow X is disposed at the lower end of the protruding portion 124E. An end in the direction of arrow X of the slide member 126 is rotatably linked to the lower end of the protruding portion 124E through the use of the link pin 124F. Accordingly, the contact portion 124C of the lever member 124 is pushed down by the boss 122 (see FIG. 7B) and rotates in the direction of arrow R1, the slide member 126 slides in the direction of arrow X.

A bracket 128 is disposed at the center of the slide member 126 in the direction of arrow X. A curved portion 128A curved in a shape convex in the direction of arrow X is formed at an end of the bracket 128 in the direction of arrow X. The curved portion 128A is configured to come in contact with the pressing target portion 104D of the link member 104 with the movement of the slide member 126 in the direction of arrow X and to cause the pressing target portion 104D to move in the direction of arrow X.

A torsion spring 129 is attached to the bracket 128. The torsion spring 129 impels the slide member 126 to move in the opposite direction of the direction of arrow X. Accordingly, when the top cover 18 of the image forming apparatus 10 is opened as shown in FIG. 7A, the lever member 124 moves in the opposite direction of the direction of arrow R1 and the slide member 126 moves in the opposite direction of the direction of arrow X with the impelling force of the torsion spring 125 as shown in FIG. 8B.

FIG. 12 shows the position of a force applied to the first shutter member 102 in the direction of arrow Z (in the axial direction of the rotation shaft 32A of the photosensitive member 32 in FIG. 5). In the photosensitive member unit 30, the points of application of a force F2 (that is, a force F2 applied to the link position between the first shutter member 102 and the second shutter member 106) for impelling the first shutter member 102 to the protective position where the first shutter member covers the photosensitive member 32 are indicated by points P1 and P4. In the photosensitive member unit 30, the points of application of a force F1 with which the protruding portions 53A (see FIGS. 4 and 5) of the intermediate transfer unit 50 impel the first shutter member 102 at the evacuated position of the first shutter member 102 are indicated by points P2 and P3.

Here, in the direction of arrow Z, the points P2 and P3 to which the force F1 for impelling the first shutter member 102 downward is applied are disposed inside the points P1 and P4 to which the force F2 for impelling the first shutter member 102 to the photosensitive member 32. In this exemplary embodiment, for example, the thickness of the first shutter member 102 is set to the minimum moldable thickness (0.6 mm) so as to suppress the rigidity of the first shutter member 102 so that the central portion in the direction of arrow Z is convex to the downside (to the side away from the intermediate transfer belt 52 (see FIG. 5)). In FIGS. 4 and 5, FIGS. 9A and 9B, and FIGS. 11A and 11B, the first shutter member 102 is shown as having a large thickness, but this is because the section including a rib is shown. The smallest thickness thereof is 0.6 mm.

An image forming process in the image forming apparatus 10 will be described below.

As shown in FIG. 2, when the image forming apparatus 10 is activated, color image data of yellow (Y), magenta (M), cyan (C), and black (K) is sequentially output to the exposing unit 48 from an image processor (not shown in the drawing) or the outside.

Subsequently, as shown in FIG. 5, the photosensitive member 32 of each photosensitive member unit 30 rotates and the outer circumferential surface of the photosensitive member 32 is charged by the corresponding charging roll 44. Then, the outer circumferential surface (the front surface) of the photosensitive members 32 charged by the charging rolls 44 are exposed with the laser beams LB emitted from the exposing unit 48 (see FIG. 2) on the basis of the image data. Accordingly, electrostatic latent images corresponding to the color image data are formed on the outer circumferential surface of the photosensitive members 32. The electrostatic latent images formed on the outer circumferential surfaces of the photosensitive members 32 are developed into toner images corresponding to the colors by the developing devices 36. The toner images on the outer circumferential surfaces of the photosensitive members 32 are sequentially transferred (in order of Y, M, C, and K) to the intermediate transfer belt 52 by the primary transfer rolls 64 to overlap with each other.

On the other hand, as shown in FIG. 2, a recording sheet P picked up from the sheet feed tray 68 and transported along the transporting path 70 is transported to the secondary transfer position (the secondary transfer roll 66) by the registration roll 76 in time with the multiple transferring of the toner images to the intermediate transfer belt 52. The toner images multiply transferred to the intermediate transfer belt 52 are secondarily transferred to the recording sheet P transported to the secondary transfer position by the secondary transfer roll 66.

Subsequently, the recording sheet P to which the toner images are transferred is transported to the fixing device 80. In the fixing device 80, the toner images on the recording sheet P are heated and pressed by the fixing roll 84 and the pressing roll 86 and are thus fixed to the recording sheet P. The recording sheet P to which the toner images are fixed is discharged to, for example, the discharge tray 26.

When images are formed on both surfaces of the recording sheet P, the leading edge and the trailing edge of the recording sheet P having an image fixed to the surface thereof by the fixing device 80 are reversed by causing the discharge rolls 88 to reversely rotate and the recording sheet P is sent to the double-side transporting path 71. The recording sheet is sent to the transporting path 70 from the upstream side of the registration roll 76 again and an image is formed and fixed to the rear surface of the recording sheet P.

The operation of this exemplary embodiment will be described below.

When the top cover 18 of the image forming apparatus 10 is opened as shown in FIGS. 3 and 7A, the lever member 124 is not pushed by the boss 122 (see FIG. 7A) as shown in FIG. 8A and thus the slide member 126 slides in the opposite direction of the direction of arrow X by the impelling force of the torsion springs 125 and 129.

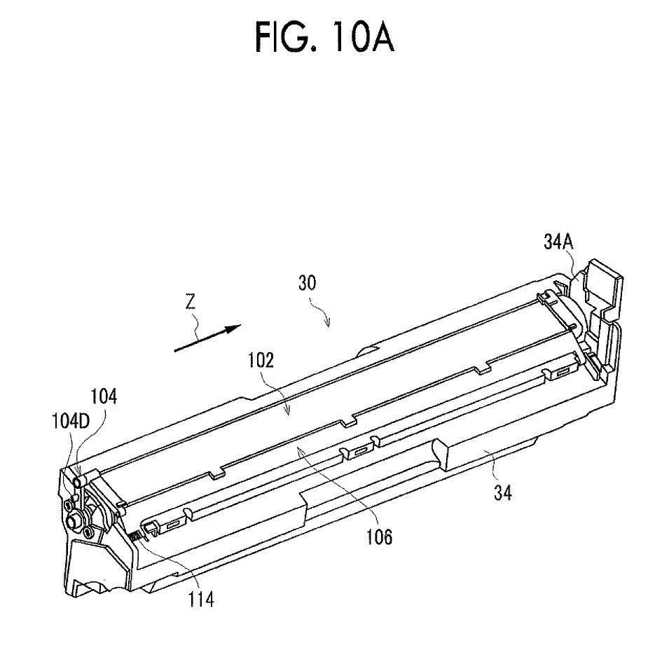

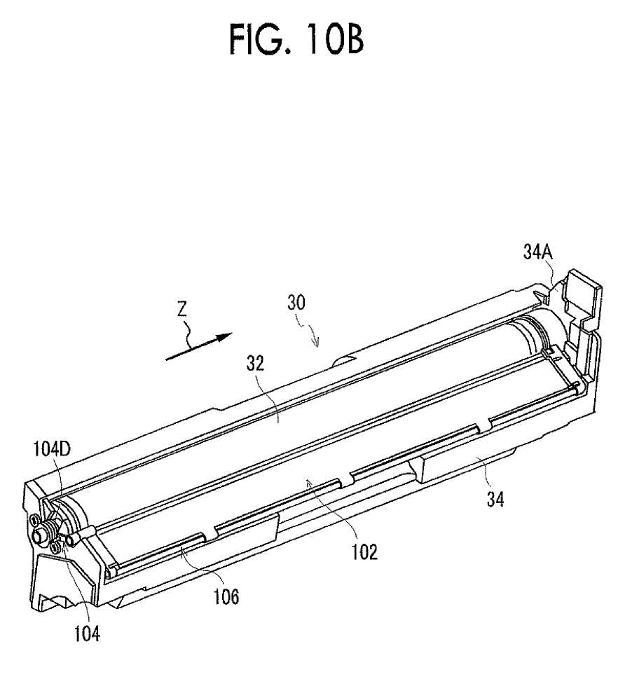

Subsequently, since the pressing target portion 104D of the link member 104 does not come in contact with the curved portion 128A of the slide member 126, the movement of the first shutter member 102 to the protective position is not regulated and thus the first shutter member 102 moves to the protective position for the photosensitive member 32 by the impelling force of the spring 114. Accordingly, as shown in FIGS. 9A, 10A, and 11A, the first shutter member 102 is located at the protective position where it is opposed to the outer circumferential surface of the photosensitive member 32 and protects the photosensitive member 32.

On the other hand, when the top cover 18 of the image forming apparatus 10 is shut as shown in FIGS. 2 and 7B, the lever member 124 can be pushed down against the impelling forces of the torsion springs 125 and 129 by the boss 122 (see FIG. 7B) with a force larger than the impelling forces as shown in FIG. 8B and thus rotates in the direction of arrow R1. Accordingly, the slide member 126 slides in the direction of arrow X.

Subsequently, since the pressing target portion 104D of the link member 104 comes in contact with the curved portion 128A of the slide member 126 and is pushed in the direction of arrow X, the first shutter member 102 moves to the evacuated position against the impelling force of the spring 114 with a force larger than the impelling force. Accordingly, as shown in FIGS. 9B, 10B, and 11B, the first shutter member 102 gets away from the position where it is opposed to the outer circumferential surface of the photosensitive member 32 and the photosensitive member 32 is exposed.

Subsequently, as shown in FIG. 5, since the first shutter member 102 is pushed down by the protruding portion 53A of the intermediate transfer unit 50 at the evacuated position, the first shutter member 102 and the second shutter member 106 are housed to overlap with each other. The exposed four photosensitive members 32 corresponding to the toner colors are disposed to be opposed to the intermediate transfer belt 52 as shown in FIG. 4.

Here, as shown in FIGS. 9A and 9B, since the first link portion 104B which is an end of the link member 104 is disposed in the rotation shaft 32A of the photosensitive member 32 and thus the rotation center of the shutter unit 100 is the same as the photosensitive member, the second link portion 104C which is the other end moves along an arc locus centered on the rotation shaft 32A. Accordingly, when the link member 104 rotates, the distance from the rotation shaft 32A to the second link portion 104C does not vary. Accordingly, it is possible to suppress the first shutter member 102 from coming in contact with the outer circumferential surface of the photosensitive member 32 and to shorten the locus along which the first shutter member 102 moves, compared with the configuration where the first link portion 104B rotates about a position other than the rotation shaft 32A.

As shown in FIG. 5, in the image forming apparatus 10, since the first shutter member 102 at the evacuated position is disposed along the intermediate transfer belt 52, it is possible to suppress the first shutter member 102 from coming in contact with the intermediate transfer belt 52. Since the first shutter member 102 at the evacuated position is pressed to the opposite side of the intermediate transfer belt 52 by the protruding portion 53A, the movement of the first shutter member 102 to the intermediate transfer belt 52 is regulated, thereby suppressing the first shutter member 102 from coming in contact with the intermediate transfer belt 52.

As shown in FIG. 12, in the image forming apparatus 10, the points of application P2 and P3 to which the force F1 for impelling the first shutter member 102 downward in the direction of arrow Z is applied are disposed inside the points of application P1 and P4 of the force F2 for impelling the first shutter member 102 to the photosensitive member 32. Accordingly, in the curved state (indicated by the curve W) of the first shutter member 102 in the direction of arrow Z, the central portion in the direction of arrow Z is convex to the downside (in the direction in which it gets away from the intermediate transfer belt 52 (see FIG. 5)). Accordingly, the central portion of the first shutter member 102 in the direction of arrow Z is suppressed from coming in contact with the intermediate transfer belt 52.

As shown in FIG. 11A, in the image forming apparatus 10, since the second shutter member 106 as well as the first shutter member 102 cover the outer circumferential surface of the photosensitive member 32 at the protective position, it is possible to broaden the protective area of the photosensitive member 32, compared with the configuration in which the photosensitive member 32 is covered with only the first shutter member 102.

As shown in FIG. 6, the urethane seal 108 is disposed on the rear surface of the first shutter member 102. As shown in FIGS. 11A and 11B, when the first shutter member 102 moves from the protective position for the photosensitive member 32 to the evacuated position, the first shutter member 102 may come close to the outer circumferential surface of the photosensitive member 32. In this case, since the urethane seal 108 is present between the first shutter member 102 and the photosensitive member 32, the first shutter member 102 is suppressed from coming in direct contact with the outer circumferential surface of the photosensitive member 32, thereby suppressing the outer circumferential surface of the photosensitive member 32 from being scratched.

In addition, since the first shutter member 102 in this exemplary embodiment has the moldable minimum thickness (0.6 mm), the distance from the intermediate transfer belt 52 can be made to increase or the evacuation area of the first shutter member 102 can be made to decrease by the decreasing thickness.

The invention is not limited to the above-mentioned exemplary embodiment.

The photosensitive member unit 30 and the corresponding developing device 36 may be integrated with each other. By causing the intermediate transfer unit 50 to move (retract) with the top cover 18 shut, the first shutter member 102 may be made to move from the evacuated position to the protective position.

Only a link portion may be formed at both ends of the second shutter member 106, similarly to the link member 104. In addition, a sponge member instead of the urethane seal 108 may be attached to the rear surface of the first shutter member 102.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image holding member unit comprising:
an image holding member that has a rotation shaft which is rotatably supported by a support member and that holds a developer image on an outer circumferential surface thereof;
a protective member that moves between a first position where the protective member covers the outer circumferential surface of the image holding member and a second position where the protective member uncovers the outer circumferential surface of the image holding member; and
a guide structure that includes a first link member of which an end is rotatably linked to the rotation shaft and the other end of which is rotatably linked to an end of the protective member in a circumferential direction of the image holding member and a second link member of which an end is rotatably linked to the other end of the protective member in the circumferential direction of the image holding member and the other end of which is rotatably linked to the support member and that guides the protective member between the first position and the second position.

2. An image forming apparatus comprising:
the image holding member unit according to claim 1; and
a transfer belt to which a developer image formed on the outer circumferential surface of the image holding member is transferred,
wherein the protective member is located at the second position along the transfer belt.

3. The image forming apparatus according to claim 2, further comprising:
a support body that supports the transfer belt so as to circulate,
wherein a protruding portion coming in contact with the protective member to press the protective member to the opposite side of the transfer belt is formed in the support body.

4. The image forming apparatus according to claim 3, wherein the protruding portion is disposed inside a link position between the protective member and at least one of the first link member and the second link member in the axial direction of the rotation shaft.

5. The image forming apparatus according to claim 2, wherein the second link member protects the image holding member when the protective member is located at the first position.

6. The image forming apparatus according to claim 3, wherein the second link member protects the image holding member when the protective member is located at the first position.

7. The image forming apparatus according to claim 4, wherein the second link member protects the image holding member when the protective member is located at the first position.

8. The image forming apparatus according to claim 2, wherein an elastic member is disposed on a surface of the protective member opposed to the image holding member.

9. The image forming apparatus according to claim 3, wherein an elastic member is disposed on a surface of the protective member opposed to the image holding member.

10. The image forming apparatus according to claim 4, wherein an elastic member is disposed on a surface of the protective member opposed to the image holding member.

11. The image forming apparatus according to claim 5, wherein an elastic member is disposed on a surface of the protective member opposed to the image holding member.

12. The image forming apparatus according to claim 6, wherein an elastic member is disposed on a surface of the protective member opposed to the image holding member.

13. The image forming apparatus according to claim 7, wherein an elastic member is disposed on a surface of the protective member opposed to the image holding member.
